(19) United States
(12) Patent Application Publication
(10) Pub. No.: US 2025/0274352 A1
(43) Pub. Date: Aug. 28, 2025

(54) REMOTE OFFLINE SEQUENTIAL NETWORK NODE ENCODER TRAINING

(71) Applicant: QUALCOMM Incorporated, San Diego, CA (US)

(72) Inventors: June Namgoong, San Diego, CA (US); Taesang Yoo, San Diego, CA (US); Abdelrahman Mohamed Ahmed Mohamed Ibrahim, San Diego, CA (US); Chenix Hao, Beijing (CN); Jay Kumar Sundararajan, San Diego, CA (US); Naga Bhushan, San Diego, CA (US); Yu Zhang, San Diego, CA (US); Pavan Kumar Vitthaladevuni, San Diego, CA (US); Runxin Wang, San Diego, CA (US)

(21) Appl. No.: 18/878,749

(22) PCT Filed: Nov. 18, 2022
(86) PCT No.: PCT/CN2022/132843

§ 371 Date: Dec. 24, 2024

(30) Foreign Application Priority Data
Aug. 10, 2022 (WO) PCT/CN2022/111368

(51) Int. Cl. H04L 41/16; H04B 7/06; H04W 24/10

(52) U.S. Cl. CPC H04L 41/16; H04B 7/0626; H04W 24/10

(57) ABSTRACT

This disclosure provides systems, methods, and devices for wireless communication that support remote offline sequential network node encoder training. In a first aspect, a method of wireless communication includes receiving, from a second network node, training information for a first encoder of the first network node, wherein the training information comprises first input information for a second encoder of the second network node and output information corresponding to the first input information, and training the first encoder of the first network node using the training information. Other aspects and features are also claimed and described.

### CROSS-REFERENCE TO RELATED APPLICATIONS

This application claims the benefit of International Patent Application No. PCT/CN2022/111368, entitled, “REMOTE OFFLINE SEQUENTIAL NETWORK NODE ENCODER TRAINING,” filed on Aug. 10, 2022, which is expressly incorporated by reference herein in its entirety.

### TECHNICAL FIELD

Aspects of the present disclosure relate generally to wireless communication systems, and more particularly, to encoder training for wireless communications. Some features may enable and provide improved communications, including remote offline sequential machine learning encoder training.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communications includes receiving, from a second network node, training information for a first encoder of the first network node, wherein the training information comprises first input information for a second encoder of the second network node and output information corresponding to the first input information, such as output information generated, based on the first input information, by the second encoder of the second network node, and training the first encoder of the first network node using the training information.

In one aspect of the disclosure, a method for wireless communication includes generating training information, wherein the training information comprises first input information for a first encoder of the first network node and output information generated, based on the first input information, by the first encoder and transmitting the training information to a second network node for training a second encoder of the second network node.

In an additional aspect of the disclosure, an apparatus includes at least one processor and a memory coupled to the at least one processor. The at least one processor is configured to receive, from a second network node, training information for a first encoder of the first network node, wherein the training information comprises first input information for a second encoder of the second network node and output information corresponding to the first input information, such as output information generated, based on the first input information, by the second encoder of the second network node, and train the first encoder of the first network node using the training information.

In an additional aspect of the disclosure, an apparatus includes at least one processor and a memory coupled to the at least one processor. The at least one processor is configured to generate training information, wherein the training information comprises first input information for a first encoder of the first network node and output information generated, based on the first input information, by the first encoder and transmit the training information to a second network node for training a second encoder of the second network node.

In an additional aspect of the disclosure, an apparatus includes means for receiving, from a second network node, training information for a first encoder of the first network node, wherein the training information comprises first input information for a second encoder of the second network node and output information corresponding to the first input information, such as output information generated, based on the first input information, by the second encoder of the second network node, and means for training the first encoder of the first network node using the training information.

In an additional aspect of the disclosure, an apparatus includes means for generating training information, wherein the training information comprises first input information for a first encoder of the first network node and output information generated, based on the first input information, by the first encoder and means for transmitting the training information to a second network node for training a second encoder of the second network node.

In an additional aspect of the disclosure, a non-transitory computer-readable medium stores instructions that, when executed by a processor, cause the processor to perform operations described herein.

In an additional aspect of the disclosure, a computer program comprises instructions that, when executed by a processor, cause the processor to perform operations described herein.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example wireless communication system that supports remote offline sequential network node encoder training according to one or more aspects.

FIG. 4 is a timing diagram illustrating an example wireless communication system that supports remote offline sequential network node encoder training according to one or more aspects.

FIG. 5 is a flow diagram illustrating an example process that supports remote offline sequential network node encoder training according to one or more aspects.

FIG. 6 is a flow diagram illustrating an example process that supports remote offline sequential network node encoder training according to one or more aspects.

FIG. 7 is a block diagram of an example UE-side server that supports remote offline sequential network node encoder training according to one or more aspects.

FIG. 8 is a block diagram of an example base station-side server that supports remote offline sequential network node encoder training according to one or more aspects. Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHZ-7.125 GHZ) and FR2 (24.25 GHz-52.6 GHz). The frequencies between FRI and FR2 are often referred to as mid-band frequencies. Although a portion of FRI is greater than 6 GHZ, FRI is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

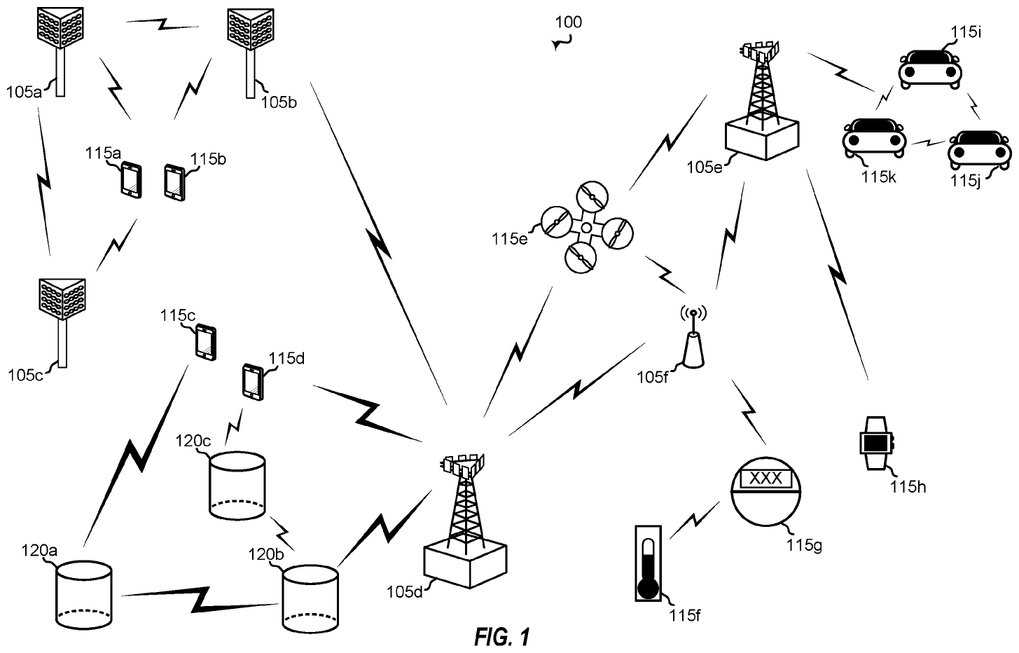

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink and/or uplink, and/or desired transmission between base stations, and/or backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c may serve UEs 115a and 115b, in particular, using 3D beamforming and coordinated spatial techniques, such as coordinated multipoint (COMP) or multi-connectivity. Macro base station 105d may perform backhaul communications with base stations 105a-105c, as well as small cell, base station 105f. Macro base station 105d may also transmit multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations may support mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

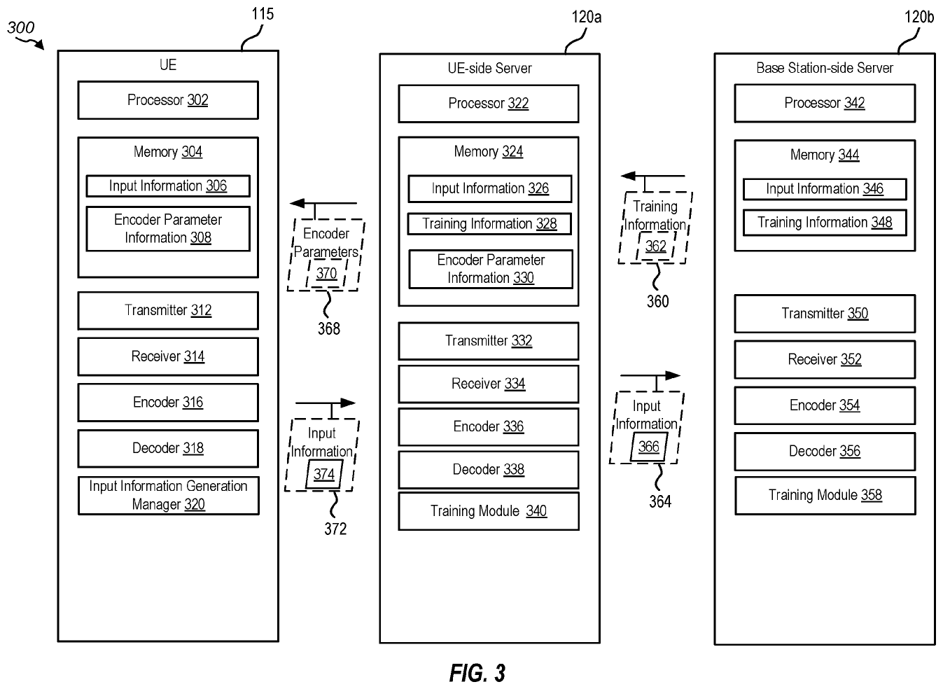

Wireless network 100 may also include one or more connected servers, such as servers 120a-c. In some embodiments, servers 120a-c may be wirelessly or otherwise connected, such as connected via a wired connection. Servers 120a and 120c may be UE-side servers and may communicate with one or more UEs, such as UEs 115c-d. For example, server 120a may be a UE-side server associated with a first UE vendor and may communicate with one or more UEs 115c associated with the first UE vendor. Server 120c may be a second UE-side server associated with a second UE vendor different from the first UE vendor and may communicate with one or more UEs 115d associated with the second UE vendor. Server 120c may have similar functionality to server 120a, as described with respect to FIGS. 3-5 and 7. Server 120b may be a base station-side server and may communicate with one or more base stations, such as base station 105d. The servers 120a-c may communicate with each other. Servers 120a-cmay communicate using a variety of wireless or wired technologies, such as Ethernet, Wi-Fi, or cellular technologies. Servers 120a and 120c may each host and train encoders for use by one or more UEs in encoding information, such as sensed channel state feedback from reference signals transmitted by one or more base stations. Server 120b may host and train a decoder for use by one or more base stations in decoding information. It is to be noted that the present disclosure is not limited thereto. For example, server 120b may also host and train an encoder for use by one or more base stations in encoding information, and servers 120a and 120c may also host and train decoders for use by one or more UEs in decoding information. Servers 120a-c may employ one or more machine learning (ML) algorithms to train hosted encoders and decoders.

In some embodiments, servers 120a-b and 120b-c may work together to train encoders for use by UEs in encoding information for transmission to base stations. For example, server 120a may provide server 120b with input information, such as sensed channel state feedback, received by the server 120a from one or more UEs. The server 120b may train a decoder and an encoder using the received input information, and may provide the server 120a with training information for use by the server 120a in training an encoder to be pushed to one or more UEs. Server 120a may train an encoder using the training information, which may include generating encoder parameters, and may transmit the encoder parameters for the trained encoder to one or more UEs, such as UE 115c or 115d, for use in encoding information to be transmitted to a base station. In some embodiments, server 120b may also receive input information from server 120c and may train an encoder using input information from both server 120a and server 120c. Server 120b may then generate training information using the input information from both servers 120a and 120c and may transmit the training information to both of servers 120a and 120c. The servers 120a and 120c may then each train an encoder using the received input information, which may include generation of encoder parameters, and may transmit one or more encoder parameters to connected UEs. Thus, the training information generated by the base station-side server 120b may be generated for one or more UE-side servers using input information from one or more UE-side servers.

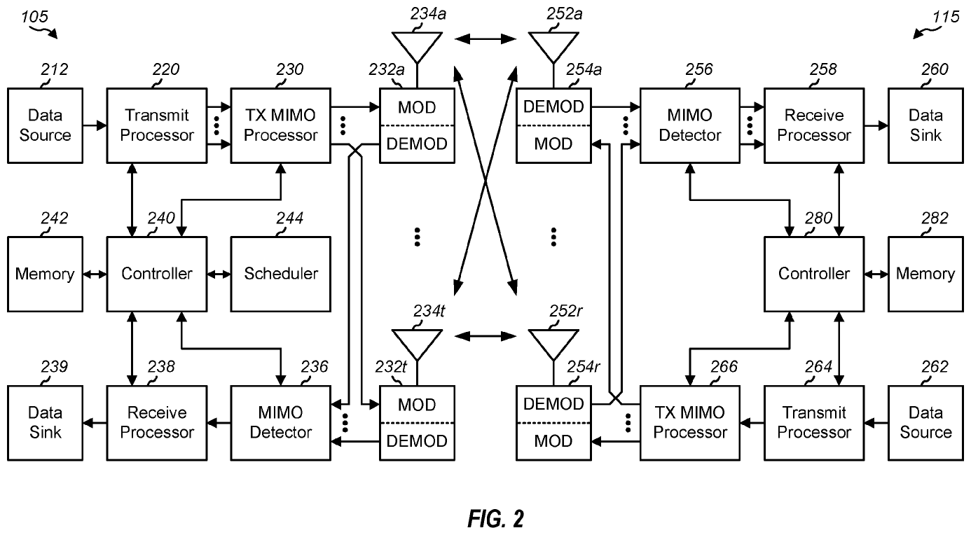

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

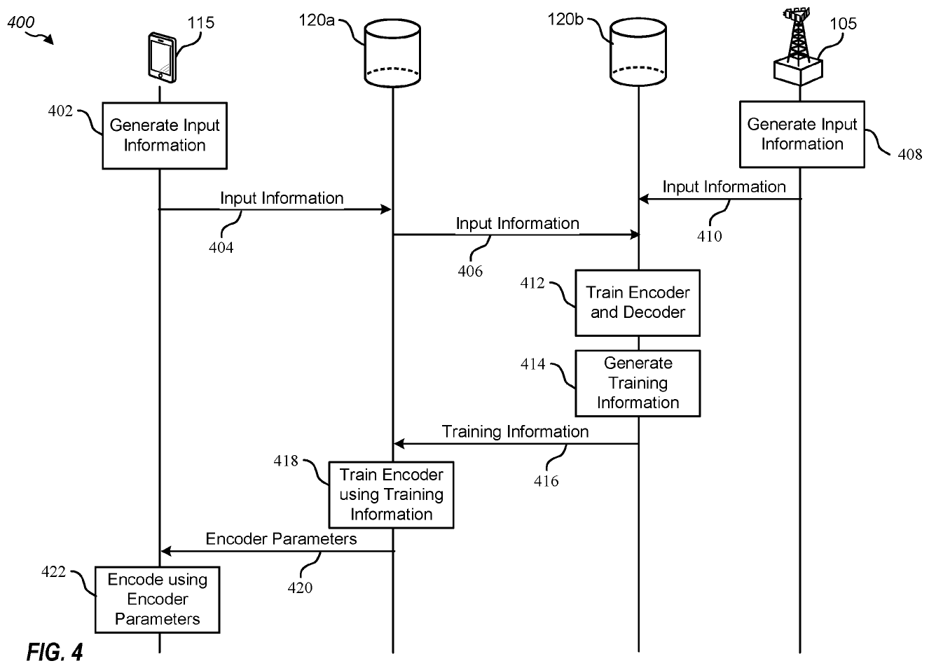

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 4-6, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

UE's and base stations designed, marketed, and maintained by different vendors may implement different encoders and decoders for encoding and decoding information, such as channel state feedback information. A UE-side server may train an encoder for implementation by one or more UEs, offline, such as by applying one or more ML algorithms to train the encoder. The UE-side server may, for example, be operated and maintained by a particular UE vendor, and may determine encoder parameters for transmission to one or more UEs associated with the particular UE vendor. In some cases, one or more UEs for which the encoder is being trained may transmit input information, such as channel state feedback information, to the first network node.

The UE-side server may transmit such input information to a base station-side server, such as a base station vendor-side server. The base station-side server may train a decoder for implementation by one or more base stations offline, such as by applying one or more ML algorithms to train the decoder. The base station-side server may, for example, be operated and maintained by a particular base station vendor and may determine decoder parameters for pushing to one or more base stations associated with the particular base station vendor. In some cases, one or more base stations for which the encoder is being trained may transmit input information, such as channel state feedback information, to the base station-side server. The base station-side server may train a decoder for one or more base stations, offline, such as by applying one or more ML algorithms to train the decoder. The base station-side server may further supervise training of encoders by one or more UE-side servers. For example, the base station-side server may receive input information from one or more UE-side servers, or from another source, and may use the input information to train both an encoder and a decoder. Such training may, for example, include application of ML algorithms to train an encoder/decoder pair to efficiently encode and decode information. The base station-side server may then encode the received input information using the trained encoder to generate training information. The training information may include both the input information and the output of the encoder, such as encoded input information. The base station-side server may transmit the training information to one or more UE-side servers, and the one or more UE-side servers may use the training information to perform offline training of the encoder of each respective UE-side server. Such training may produce one or more encoder parameters for use by one or more UEs in encoding information, and the encoder parameters may be transmitted by the one or more UE-side servers to one or more UEs. It is to be noted that the training information including both input information and output of the encoder is a specific example, and training information with other types or forms can apply to the present disclosure.

In some embodiments, a UE-side server may train a decoder for implementation by one or more UEs, offline, such as by applying one or more ML algorithms to train the decoder. The UE-side server may determine decoder parameters for transmission to one or more UEs. In some cases, the one or more UEs for which the decoder is being trained may transmit input information to the UE-side server. In some cases, the UE-side server may train the decoder using the input information received from the one or more UEs. The UE-side server may transmit such input information to a base station-side server. The base station-side server may train an encoder for implementation by one or more base stations offline, such as by applying one or more ML algorithms to train the encoder. The base station-side server may further supervise training of decoders by one or more UE-side servers. For example, the base station-side server may receive input information from one or more UE-side servers, or from another source, and may use the input information to train both an encoder and a decoder. The base station-side server may transmit the training information to one or more UE-side servers, and the one or more UE-side servers may use the training information to perform offline training of the decoder of each respective UE-side server. Such training may produce one or more decoder parameters for use by one or more UEs in decoding information, and the decoder parameters may be transmitted by the one or more UE-side servers to one or more UEs.

Training an encoder used by one or more UEs may facilitate better interoperability between the one or more UEs and one or more base stations. For example, a UE may generate channel state feedback (CSF) information and may encode the CSF information. In some cases, such encoding may generate compressed CSF information. The compressed CSF information may be transmitted to one or more base stations, such as one or more gNBs. The one or more base stations may decode the received encoded CSF information to generate decoded or reconstructed CSF information, such as one or more reconstructed precoding vectors. Training an encoder and a decoder for such encoding and decoding using one or more ML algorithms may enable more efficient encoding and decoding of CSF information. Such training may be performed for X-node, or two-sided, CSF operations, where a UE communicates encoded CSF information with a base station that decodes the encoded CSF information. It is to be noted that the CSF information is a specific example of information to be encoded and/or decoded at the one or more UEs and the one or more base stations, and in the present disclosure, an encoder and a decoder may also be trained for other types of information to be encoded and/or decoded at the one or more UEs and the one or more base stations.

Use of a training information set from a base station-side server may facilitate better interoperability between an encoder trained by the UE-side server and a decoder trained by the base station-side server. Furthermore, the encoder of the UE-side server may be trained by using the training information set from the base station-side server without sharing of an architecture of a decoder or encoder used and/or trained by the base station-side server. Thus, a vendor operating the base station-side server may be able to facilitate interoperability of a base station decoder with UE encoders without revealing proprietary details of a trained encoder or decoder. For example, if a base station-side server trains an encoder along with a decoder, and the encoder is then shared with a UE-side server, the UE-side server may be able to reverse engineer the shared encoder to determine the architecture of the corresponding decoder, such as to determine one or more implementation details of a modem of the base station, due to symmetry present between the encoder and the decoder. As one particular example, if the trained encoder employs convolutional layers, the trained decoder may employ the transpose convolutional layers of those employed by the encoder, and the encoder may be used to determine the transpose convolutional layers of the decoder. Thus, use of vendor-specific base station-side and UE-side servers to share training information may allow base station and UE vendors to cooperate in training encoder/decoder pairs for UEs and base stations without sharing proprietary details regarding encoder and/or decoder architecture. A base station-side server may also be a base station vendor-specific server, and a UE-side server may be a UE vendor-specific server.

FIG. 3 is a block diagram of an example wireless communications system 300 that supports remote offline sequential network node encoder training according to one or more aspects. In some examples, wireless communications system 300 may implement aspects of wireless network 100. Wireless communications system 300 includes UE 115, UE-side server 120a, and base station-side server 120b. Although one UE 115, one UE-side server 120a, and one base station-side server 120b are shown, wireless communications system 300 may generally include multiple UEs 115, may include more than one UE-side server 120a, may include more than one base-station side server 120b, and may include one or more base stations. In general, the servers 120a-120c may each host and train coders for use by one or more UEs or one or more base stations in coding information, wherein coding may refer to encoding and decoding. Examples presented herein for encoding may likewise apply—mutatis mutandis—to decoding. Similarly, examples presented in the following for decoding may likewise apply—mutatis mutandis—to encoding.

UE 115 may include a variety of components (such as structural, hardware components) used for carrying out one or more functions described herein. For example, these components may include one or more processors 302 (hereinafter referred to collectively as “processor 302”), one or more memory devices 304 (hereinafter referred to collectively as “memory 304”), one or more transmitters 312 (hereinafter referred to collectively as “transmitter 312”), and one or more receivers 314 (hereinafter referred to collectively as “receiver 314”). Processor 302 may be configured to execute instructions stored in memory 304 to perform the operations described herein. In some implementations, processor 302 includes or corresponds to one or more of receive processor 258, transmit processor 264, and controller 280, and memory 304 includes or corresponds to memory 282.

Memory 304 includes or is configured to store input information 306 and encoder parameter information 308. Input information 306 may, for example, include CSF information. CSF information may, for example, include one or more measurements performed by a UE on one or more signals transmitted by a base station, such as one or more channel state information reference signals (CSI-RS) transmitted by the base station. In some embodiments, CSF information may include sensed raw channel information or singular vector information for one or more beamforming vectors. Input information 306 may be categorized by a vendor of a base station with which the input information is associated or by a model of a base station with which the input information is associated. For example, input information 306 including sensing or measurement information of one or more signals from base stations identified with a first vendor may be categorized as input information associated with base stations identified with the first vendor. Encoder parameter information 308 may include one or more encoder parameters for an encoder 316 of the UE 115. Such parameters 308 may, for example, be received from the UE-side server 120a. The UE 115 may use the encoder parameter information 308 to adjust operation of the encoder 316 for encoding information to be transmitted to a base station, such as for encoding CSF information for transmission to a base station. In some embodiments, the encoder parameter information 308 may include instructions, code, or neural network weights and biases received from the UE-side server 120a for the encoder 316.

Transmitter 312 is configured to transmit reference signals, control information and data to one or more other devices, and receiver 314 is configured to receive references signals, synchronization signals, control information and data from one or more other devices. For example, transmitter 312 may transmit signaling, control information and data to, and receiver 314 may receive signaling, control information and data from, UE-sider server 120a or one or more base stations. In some implementations, transmitter 312 and receiver 314 may be integrated in one or more transceivers. Additionally or alternatively, transmitter 312 or receiver 314 may include or correspond to one or more components of UE 115 described with reference to FIG. 2.

The encoder 316 of the UE 115 may be an encoder for encoding information to be transmitted to one or more base stations, such as for encoding CSF information. In some embodiments, the encoder 316 may be an encoder trained offline by the UE-side server 120a and may operate according to encoder parameter information 308. The decoder 318 may be a decoder for decoding information received by the UE 115. The UE 115 may also include an input information generation manager 320. The input information generation manager 320 may generate input information 306, such as by sensing or measuring one or more signals from one or more base stations or processing sensed or measured information.

UE-side server 120a may include a variety of components (such as structural, hardware components) used for carrying out one or more functions described herein. For example, these components may include one or more processors 322 (hereinafter referred to collectively as “processor 322”), one or more memory devices 324 (hereinafter referred to collectively as “memory 324”), one or more transmitters 332 (hereinafter referred to collectively as “transmitter 332”), and one or more receivers 334 (hereinafter referred to collectively as “receiver 334”). Processor 322 may be configured to execute instructions stored in memory 324 to perform the operations described herein.

Memory 354 includes or is configured to store input information 326, training information 328, and encoder parameter information 330. The input information 326 may, for example, be input information received from one or more UEs, such as UE 115. The UE-side server 120a may be associated with, such as maintained or operated by, a particular UE vendor and may communicate with UEs associated with the particular UE vendor. Therefore, the input information 326 may include input information from UEs associated with the vendor with which the UE-side server is associated. Such UEs may, for example, include one or more UEs using one or more encoder parameters for an encoder trained by the UE-side server 120a. In some embodiments, the input information 326 may be categorized according to a vendor with which a base station that transmitted signals for generating the input information is associated. Training information 328 may include training information received from base station-side server 120b. Such training information may, for example, include input information 326 and associated output information from an encoder of the base station side-server 120b. The training information 328 may, for example, include input information that was provided to the encoder of the base station-side server 120b as input and output information, such as the encoded input information, corresponding to the first input information. The output information may, for example, be generated by the encoder in encoding the provided input information. The input and output information of the training information 328 may, for example, be organized in input and associated output tuples. In some embodiments, the training information 328 may include training information received from multiple base station-side servers associated with or operated by different vendors. The encoder parameter information 330 may include one or more parameters of an encoder 336 trained by the UE-side server offline for transmission to the UE 115. For example, the encoder parameter information may include instructions or code to be executed by an encoder 316 of the UE 115.

Transmitter 332 is configured to transmit reference signals, synchronization signals, control information and data to one or more other devices, and receiver 334 is configured to receive reference signals, control information and data from one or more other devices. For example, transmitter 332 may transmit signaling, control information and data to, and receiver 334 may receive signaling, control information and data from, UE 115 or base station-side server 120b. In some implementations, transmitter 332 and receiver 334 may be integrated in one or more transceivers.

The UE-side server 120a may include an encoder 336 for encoding information. The encoder 336 may be an encoder trained by the UE-side server 120a, and, in some embodiments, the UE-side server 120a may not use the encoder for encoding information to be transmitted. The encoder 336 may be trained by an encoder training module 340 of the UE-side server. For example, the encoder training module 340 may employ one or more ML algorithms to train the encoder 336 using the training information 328. For example, if the training information 328 includes input information and associated output information, the training module 340 may adjust parameters of the encoder 336 such that the encoder produces similar output information to the output information of the training information 328 when the input information of the training information 328 is input to the encoder 336. The decoder 338 may, for example, decode information received by the UE-side server 120a.

Base station-side server 120b may include a variety of components (such as structural, hardware components) used for carrying out one or more functions described herein. For example, these components may include one or more processors 342 (hereinafter referred to collectively as “processor 342”), one or more memory devices 344 (hereinafter referred to collectively as “memory 344”), one or more transmitters 350 (hereinafter referred to collectively as “transmitter 350”), and one or more receivers 352 (hereinafter referred to collectively as “receiver 352”). Processor 342 may be configured to execute instructions stored in memory 344 to perform the operations described herein.

Memory 354 includes or is configured to store input information 346 and training information 348. As discussed above, the input information 346 may be input information received from the UE-side server 120a and used, by the base station-side server 120b, in training an encoder 354 or a decoder 356 of the base station-side server 120b. In some embodiments, the input information 346 may be received from other sources, such as from base stations associated with a same vendor as the base station-side server 120b or base stations implementing a decoder trained by the base station-side server 120b. Such input information 346 may include measurement information received from such base stations, such as one or more measurements performed on one or more sounding reference signals (SRS) by the one or more base stations. In some embodiments, the input information 346 may include input information received from multiple UE-side servers, such as from multiple UE-side servers associated with different UE vendors. Training information 348 may, for example, be training information generated using encoder 354. For example, input information 346 may be passed through encoder 354 after it is trained to generate training information 348. The training information 348 may, for example, include input information 346 and output information output from the encoder when the input information 346 is input. The output information of the training information 348 may, for example, be encoded input information 346.

Transmitter 350 is configured to transmit reference signals, synchronization signals, control information and data to one or more other devices, and receiver 352 is configured to receive reference signals, control information and data from one or more other devices. For example, transmitter 350 may transmit signaling, control information and data to, and receiver 352 may receive signaling, control information and data from, UE-side server 120a or one or more base stations. In some implementations, transmitter 350 and receiver 352 may be integrated in one or more transceivers.

The base station-side server 120b may include an encoder 354 for encoding information. The encoder 354 may be an encoder trained by the base station-side server 120b. Similarly, the decoder 256 may be a decoder trained by the base station-side server 120b, and, in some embodiments, the base station-side server 120b may not use the decoder 356 for decoding information that is received. The encoder 354 and/or decoder 356 may be trained by a training module 358 of the base station-side server 120b. For example, the training module 358 may employ one or more ML algorithms to train the encoder 354 and/or the decoder 356 using the input information 346. For example, the training module 358 may adjust parameters of the encoder 354 and/or the decoder 356 to enhance operation of the encoder and/or decoder in encoding and/or successively decoding input information. When the encoder 354 and the decoder 356 are trained, the base station-side server 120b may encode the input information 346 using the trained encoder 354 to generate the training information 348 including both the input information 346 and the output of the encoder 354.

In some implementations, wireless communications system 300 implements a 5G NR network. For example, wireless communications system 300 may include multiple 5G-capable UEs 115 and multiple 5G-capable base stations 105, such as UEs and base stations configured to operate in accordance with a 5G NR network protocol such as that defined by the 3GPP, along with servers, such as UE-side server 120a and base station-side server 120b that facilitate training of encoders and decoders of UEs 115 or base stations 105.

During operation of wireless communications system 300, the UE 115 may transmit a message 372 including input information 374 to the UE-side server 120a. The input information 374 may, for example, be input information 306. The UE-side server 120a may transmit a message 364 including input information 366 to the base station-side server 120b. The input information 366 may, for example, be input information 326. For example, the input information 366 may include input information collected by the UE-side server 120a from multiple UEs. In some embodiments, the base station-side server 120b may receive messages with input information from additional UE-side servers, such as UE-side server 120c of FIG. 1. After generating training information 348, the base station-side server 120b may transmit a message 360 including training information 662 to the UE-side server 120a. The UE-side server may train encoder 336 based on received training information and may transmit a message 368 including encoder parameter information 370 to the UE 115. Thus, the base station-side server 120b may control training of an encoder for one or more UEs 115.

FIG. 4 is a timing diagram for a system 400 that supports remote offline network node encoder training. The system 400 may include a UE 115, a UE-side server 120a, a base station-side server 120b, and a base station 105. The UE 115 and the UE-side server 120a may be associated with a same UE vendor, such as a same manufacturer or designer. For example, the UE-side server 120a may train one or more encoders for implementation by UEs associated with a particular vendor, and the UE-side server 120a may be operated by the same vendor. The base station-side server 120b may control training of one or more encoders by the UE-side server 120a by generating training information for use by the UE-side server 120a in training one or more encoders. Such control may enable interoperability and enhanced encoding and decoding efficiency and reliability between encoders implemented by UEs, such as UE 115, and decoders implemented by base stations, such as base station 105, without requiring a vendor operating the base station-side server 120b to reveal details of decoders or encoders trained by the base station-side server 120b and implemented on one or more base stations, such as without revealing decoder output information or encoder parameters. In some embodiments, the system 400 may include multiple UE-side servers associated with multiple respective UE vendors or multiple base station-side servers associated with multiple base station-side servers. For example, a single base station-side server 120b in a single training session may train an encoder using input information received from multiple UE-side servers associated with different respective UE vendors and may generate and transmit a same set of training information to the multiple UE-side servers associated with the different respective UE vendors.

At 402, the UE 115 may generate input information. The input information may, for example, include CSF information. Generating input information at 402 may include performing one or more measurements of one or more signals, such as CSI-RS, transmitted by one or more base stations, such as base station 105. Base stations that transmit signals for measurement by a UE 115 in generating CSF information may, for example, include base stations associated with the same vendor as the base station-side server 120b. In some embodiments, the UE 115 may generate input information using signals received from multiple base stations associated with multiple vendors.

At 404, the UE 115 may transmit input information to the UE-side server 120a. The UE-side server 120a may, for example, be a UE-side server operated by or associated with a same vendor as a vendor associated with the UE 115. The transmitted input information may, for example, include input information generated based on signals from multiple base stations associated with multiple different respective vendors, multiple base stations associated with a single vendor, or a single base station associated with a single vendor. In some embodiments, input information generated based on signals received from base stations associated with different vendors may be identified for separate processing by the UE-side server 120a. The UE-side server 120a may receive input information from multiple UEs associated with the same vendor as the UE-side server 120a. Thus, in some embodiments, the UE-side server 120a may store multiple sets of input information associated with multiple respective base station vendors.

At 406, the UE-side server 120a may transmit input information to the base station-side server 120b. The input information transmitted at 406 may be input information received by the UE-side server 120a from one or more UEs, such as UE 115. In some embodiments, the input information transmitted at 406 may be input information generated by one or more UEs based on signals received from one or more base stations associated with a same vendor as the base station server 120b. In some embodiments, the base station-side server 120b may receive input information from multiple UE-side servers, such as input information from multiple UE-side servers associated with different respective vendors. The input information received by the base station-side server 120b may be input information generated based on signals transmitted by base stations associated with a same vendor as the base station-side server 120b. Thus, in some embodiments, the input information received by the base station-side server 120b may be associated with a same vendor as the base station-side server 120b but multiple respective UE vendors, and the base station-side server 120b may maintain multiple sets of input information received from multiple UE-side servers associated with different respective UE vendors.

At 408, base station 105 may generate input information. Base station 105 may, for example, be a base station associated with a same vendor as base station-side server 120b. Base station 105 may, for example, use a decoder trained by base station-side server 120b to decode information received from UEs. Base station 105 may generate input information by sensing or performing one or more measurements of one or more sounding reference signals. At 410, the base station 105 may transmit the generated input information to the base station-side server 120b. Thus, the base station-side server 120b may receive input information from one or more UE-side servers or from one or more base stations.

At 412, the base station-side server 120b may train an encoder and a decoder. For example, the base-station side server 120b may train a decoder to determine one or more decoder parameters for transmission to one or more base stations. The base station-side server 120b may train a corresponding encoder to generate training information. The base station-side server may train the encoder and decoder using input information received at 406 or 410. In some embodiments, the base station-side server 120b may train the encoder and decoder using one or more ML algorithms. In some embodiments, the base station-side server 120b may train the encoder and decoder using both input information received from base station 105 and input information received from UE-side server 120a, or other input information.

At 414, the base station-side server 120b may generate training information. For example, when the encoder is trained, the base station-side server may provide input information to the encoder, such as input information received at 406 or input information received at 410. The trained encoder may encode and output the encoded input information. The combined input information and output information, such as the encoded input information, may be training information.

In some embodiments, the base station-side server 120b may train encoders at 412 and generate training information at 414 for each of multiple UE-side servers associated with different UE vendors. For example, the base station-side server 120b may train encoders that are specific to particular UE vendors. In some embodiments, the base station-side server 120b may train a single encoder and generate single training information for multiple UE vendors using input information from the multiple UE vendors in a single training session. In some embodiments, the base station-side server 120b may train multiple encoders. The base station-side server 120b may generate multiple sets of training information, such as multiple sets of training information for multiple UE-side servers. For example, sets of training information for specific UE-side servers may be generated by passing input information received from each respective UE-side server through encoders trained with input information from each respective UE-side server or by passing sets of input information received from each respective UE-side server through a single encoder to generate the sets of training information.

At 416, the base station-side server 120b may transmit the training information to the UE-side server 120a. At 418, the UE-side server 120a may train an encoder using the training information. In some embodiments, the UE-side server 120a may train multiple encoders using multiple sets of training information received from multiple respective base station-side servers associated with different vendors. Training the encoder may include applying one or more ML algorithms to generate encoder parameters. Encoder parameters may, for example, include computer code, instructions, neural network weights and biases, or other encoder parameters for use by the UE 115. In some embodiments, to train the encoder, the UE-side server 120a may pass input information of input-output tuples of the training information through the encoder and may adjust parameters of the encoder until the output of the encoder is close to or matches the output of the respective tuple. When the encoder is trained, the UE-side server 120a may, at 420, transmit encoder parameters to the UE 115. At 422, the UE 115 may encode information using the received encoder parameters. Thus, the base station-side server 120b may provide training information for training an encoder to be used by one or more UEs. Such training may be remote, as a remote UE-side server and a remote base station-side server may cooperate to train an encoder for use by one or more UEs, the training may be offline, as the UE-side server and the base station-side server may train an encoder while the encoder is not being used to encode information for transmission, and the training may be sequential, as the base station-side server may train an encoder to generate training information for use by the UE-side server in training an encoder.

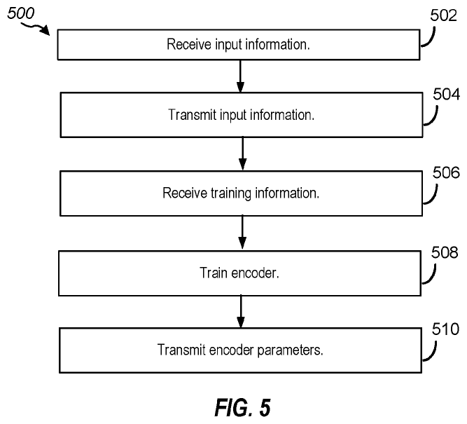

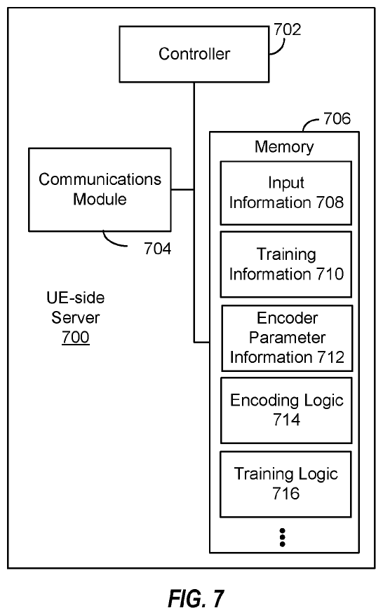

FIG. 5 is a flow diagram illustrating an example process 500 that supports remote offline sequential network node training. Operations of process 500 may be performed by a UE-side server, such as UE-side server 120a described above with reference to FIGS. 1, 3, and 4, or a UE-side server described with reference to FIG. 7. For example, operations (also referred to as “blocks”) of process 500 may enable UE-side server 120a to support remote offline sequential network node training.

At block 502, the UE-side server may receive input information. For example, the UE-side server may receive CSF information from one or more UEs. The CSF information may include one or more measurements of one or more CSI-RS measured or sensed by the one or more UEs from one or more base stations associated with one or more vendors. For example, the input information may include raw channel information or singular vector information. The UEs from which input information is received may be UEs associated with a same vendor as the UE-side server. The received input information may be categorized according to base stations that transmitted the signals based upon which the input information was generated by the respective UEs. For example, received input information may be categorized according to a vendor associated with the base station that transmitted the signals based upon which the input information was generated. Thus, a UE-side server may maintain multiple sets of input information associated with multiple respective base station vendors.

At block 504, the UE-side server may transmit input information to a base station-side server. The base station-side server may, for example, be a base station-side server associated with a particular vendor, such as a base station-side server that trains a decoder for base stations associated with the particular vendor. The transmitted input information may, for example, be input information that was generated by UEs based on signals transmitted by base stations associated with the particular vendor. Alternatively or additionally, the input information may be input information that was generated by UEs based on signals transmitted by base stations associated with a variety of respective vendors. In some embodiments, the UE-side server may not transmit input information to a base station-side server, and the base station-side server may receive input information from other sources, such as other UE-side servers or base stations.

At block 506, the UE-side server may receive training information from a base station-side server. The training information may, for example, include input information that was passed through a trained encoder of the base station-side server and output information corresponding to the first input information, such as output information generated, by the encoder of the base station-side server, based on the input information. The input information included in the training information may include input information transmitted by the UE-side server at block 504. The input information included in the training information may also include other input information not transmitted by the UE-side server, such as input information received by the base station-side server from one or more other UE-side servers. The input information and output information of the training information may, for example, be comprised in one or more input-output tuples, indicating input information and associated output information. The output information of the training information may, for example, be encoded input information generated by an encoder trained using the input information. For example, the input information may comprise CSF information, such as raw channel information or singular vector information, and the output information may comprise encoded CSF information, such as encoded raw channel information or encoded singular vector information. In some embodiments, the input information of the training information may include input information from sources other than the UE-side server, such as other UE-side servers or base stations. For example, the input information may include measurement information from one or more base stations generated based on one or more measurements performed on one or more sounding reference signals by the one or more base stations.

At block 508, the UE-side server may train an encoder using the received training information. For example, the UE-side server may apply one or more ML algorithms to train the encoder using the received training information, adjusting one or more parameters of the encoder to generate, from the input information of the training information, output information that matches the output information of the training information. In some embodiments, the UE may train multiple encoders using multiple respective sets of training information from multiple respective base station-side servers. For example, the UE-side server may train an encoder for each of multiple base station vendors with which base station-side servers from which training information is received are associated. In some embodiments, the UE may train a single encoder using multiple sets of training information from multiple base station-side servers associated with different respective vendors. In training the encoder, the UE-side server may generate one or more encoder parameters. Encoder parameters may include, for example, instructions for operating the encoder, computer code for operating the encoder, neural network weights and biases for the encoder, or other encoder parameters.

At block 510, the UE-side server may transmit one or more encoder parameters. For example, the UE-side server may transmit instructions or computer code for operating the trained encoder, or neural network weights and biases for the trained encoder, to one or more UEs connected to the UE-side server. The UEs may then use the encoder parameters for the trained encoder to encode information, such as channel state feedback information, for transmitting to base stations. For example, the UEs may adjust one or more parameters of encoders operated by the UEs based on the received encoder parameters.

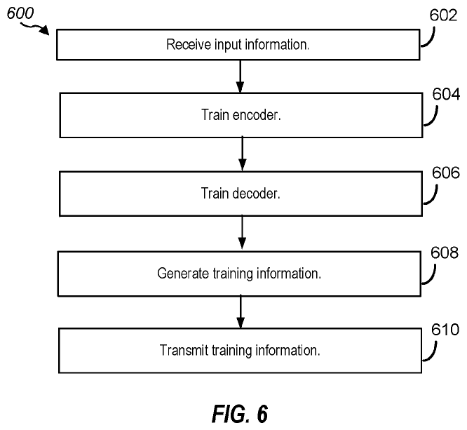

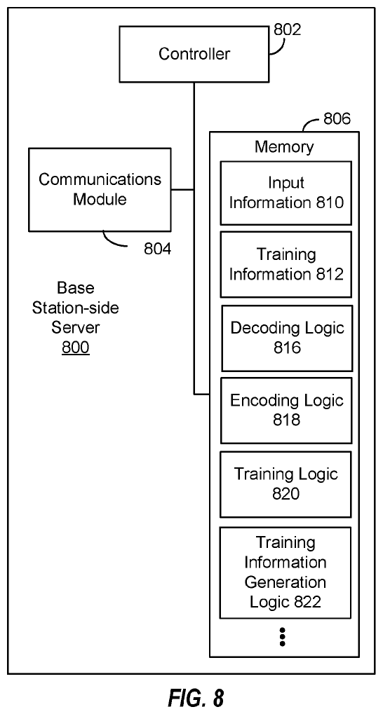

FIG. 6 is a flow diagram illustrating an example process 600 that supports remote offline sequential network node training. Operations of process 600 may be performed by a base station-side server, such as base station-side server 120b described above with reference to FIGS. 1, 3, and 4, or a base station-side server described with reference to FIG. 8. For example, operations (also referred to as “blocks”) of process 600 may enable base station-side server 120b to support remote offline sequential network node training.

At block 602, the base station-side server may receive input information. As discussed herein, such input information may be received from one or more UE-side servers, one or more base stations, or one or more other sources. For example, the base station-side server may receive input information from one or more base stations associated with a same vendor as the base station server. The input information may, for example, include channel state feedback information, or measurement information generated based on one or more measurements performed on signals transmitted by one or more base station, such as one or more SRS. Input information received from one or more base stations may, for example, be a public information set and may not correspond to UEs or UE-side servers of a particular UE vendor. In some embodiments, the input information received by the base station-side server may be input information associated with a vendor of the base station-side server, such as input information generated based on signals transmitted by base stations associated with the vendor of the base station side server. In some embodiments, the input information may be input information associated with multiple base station vendors. In some embodiments, the input information may be input information generated by UEs associated with a particular UE vendor and aggregated by a UE-side server associated with the same UE vendor. In some embodiments, input information received by the base station-side server may be input information generated by UEs associated with multiple UE vendors and aggregated by multiple UE-side servers associated with the multiple respective vendors. Thus, the input information may be received from a variety of sources as described herein.

At block 604, the base station-side server may train an encoder. At block 606 the base station-side server may train a decoder. In some embodiments, the base station-side server may employ one or more ML algorithms to train the encoder and the decoder separately or together. The base station-side server may train the encoder for purposes of generating training information for transmission to one or more UE-side servers. The base station-side server may train the decoder for generation of one or more decoder parameters for transmission to one or more base stations. The encoder and the decoder may be trained together to facilitate more efficient interoperability of UEs, using an encoder governed by one or more encoder parameters generated by a UE-side server using training information from the encoder of the base station-side server, and base stations, using a decoder governed by one or more decoder parameters generated by the base station-side server. The encoder and decoder may be trained using any combination of input information received by the base station-side server. In some embodiments, the base station-side server may train more than one encoder and more than one decoder, such as training multiple encoders using respective input information associated with respective UE vendors. In some embodiments, the base station-side server may train an encoder using input information generated by UEs associated with multiple different vendors and aggregated by and received from multiple respective UE-side servers associated with each of the respective different vendors. Thus, in some embodiments, a single encoder may be trained using information associated with multiple different UE vendors in a single training session.

At block 608, the base station-side server may generate training information. For example, when the encoder is trained, the base station-side server may provide input information to the encoder, and the encoder may generate output information using the provided input information. The output information may, for example, be encoded input information. The training information may include both the provided input information and the generated output information. For example, the training information may include one or more input-output tuples including input information and output information generated based on the input information. As one particular example, the base station-side server may provide raw channel information or singular vector information to the encoder, and the encoder may output encoded raw channel information or encoded singular vector information. The training information may thus include the raw channel information or singular vector information and encoded raw channel information or singular vector information. The base station-side server may generate one set of training information for transmission to multiple UE-side servers or may generate multiple sets of training information for transmission to multiple respective UE-side servers. For example, an encoder trained with input information from a particular UE-side server may be used to generate training information based on the input information from the particular UE-side server for the particular UE-side server. As another example, an encoder trained with input information from multiple UE-side servers associated with multiple different respective UE vendors may be used to generate training information based on the input information from the multiple UE-side servers associated with the multiple UE vendors.

At 610, the base station-side server may transmit the training information. For example, the base station-side server may transmit training information to a UE-side server for use by the UE-side server in training an encoder for use by one or more UEs in encoding information for transmission to one or more base stations. In some embodiments, the base station-side server may transmit a single set of training information to multiple UE-side servers associated with multiple respective UE vendors, while in other embodiments the base station-side server may transmit different sets of training information to different UE-side servers, such as sets of training information generated for specific respective UE-side servers. For example, multiple UE-side servers associated with different vendors may participate in a same training session with a single base station-side server. The base station-side server may train a single encoder using input information from the multiple UE-side servers and may generate a single training information set for transmission to the multiple UE-side servers. Thus, a base station-side server may function as a teacher in training one or more student UE-side server encoders in a knowledge distillation process. The training performed by the UE-side server of the encoder may become supervised learning using the training information from the base station-side server. Because training information is shared with the UE-side server by the base station-side server, the UE-side server may not have knowledge of the encoder trained by the base station-side server. As a result, the encoder trained by the UE-side server may employ a different architecture from an architecture employed by the encoder trained by the base station-side server.

FIG. 7 is a block diagram of an example UE-side server 700 supports remote offline sequential network node training in one or more aspects. UE-side server 700 may be configured to perform operations, including the blocks of a process described with reference to FIGS. 4-5. In some implementations, UE-side server 700 includes the structure, hardware, and components shown and described with reference to UE-side server 120a of FIG. 3. For example, UE-side server 700 includes controller 702, which operates to execute logic or computer instructions stored in memory 706, as well as controlling the components of UE-side server 700 that provide the features and functionality of UE-side server 700. UE-side server 700, under control of controller 702, transmits and receives signals via communications module 704. For example, the communications module 704 may include various components and hardware, such as an ethernet module, a Bluetooth module, a Wi-Fi module, or other communications modules.

As shown, memory 706 may include input information 708, training information 710, encoder parameter information 712, encoding logic 714, and training logic 716. Input information 708 may, for example, include channel state feedback information or other input information as discussed herein. Training information 710 may include training information received from one or more base station-side servers as discussed herein. Encoder parameter information 712 may include one or more encoder parameters for one or more encoders trained by the UE-side server as discussed herein. Encoding logic 714 may include logic for one or more encoders trained by the UE-side server 700 and may be configured to encode information as discussed herein. Training logic 716 may include logic for training an encoder, such as an encoder of encoding logic 714, using the training information 710 and may train the encoder to generate one or more elements of encoder parameter information 712 as discussed herein. UE-side server 700 may receive signals from or transmit signals to one or more network entities, such as UE 115 or base station-side server 120b of FIGS. 1 and 3-4 or a base station-side server 800 as illustrated in FIG. 8.

FIG. 8 is a block diagram of an example base station-side server 800 that supports remote offline sequential network node encoder training according to one or more aspects. Base station-side server 800 may be configured to perform operations, including the blocks of process 600 described with reference to FIG. 6. In some implementations, base station-side server 800 includes the structure, hardware, and components shown and described with reference to base station-side server 120b of FIGS. 1, 3-4. For example, base station-side server 800 may include controller 802, which operates to execute logic or computer instructions stored in memory 806, as well as controlling the components of base station-side server 800 that provide the features and functionality of base station-side server 800. Base station-side server 800, under control of controller 802, transmits and receives signals communications module 804. For example, the communications module 804 may include various components and hardware, such as an ethernet module, a Bluetooth module, a Wi-Fi module, or other communications modules.

As shown, the memory 806 may include input information 810, training information 812, decoding logic 816, encoding logic 818, training logic 820, and training information generation logic 822. Input information 810 may, for example, include input information received from one or more UE-side servers or from one or more base stations, as discussed herein. Training information 812 may, for example, include input information and respective output information for an encoder trained by the base station-side server 800, as discussed herein. Decoding logic 816 may be configured to decode information, such as according to one or more decoding parameters. Decoding logic 816, for example, may include one or more associated parameters for transmission to one or more base stations for use in decoding information. Encoding logic 818 may be configured to encode information, such as according to one or more encoding parameters. Training logic 820 may be configured to train an encoder and a decoder of the base station-side server 800 using input information 810, such as by adjusting one or more parameters of the encoding logic 818 and the decoding logic 816. Training information generation logic 822 may be configured to generate training information using a trained encoder of the base station-side server, such as by providing input information 810 to trained encoding logic 818 to encode the input information and pairing the encoded information in one or more tuples with the input information from which the encoded information was generated. Base station 800 may receive signals from or transmit signals to one or more UE-side servers, such as UE-side server 120a of FIGS. 1, 3-4 or UE-side server 700 of FIG. 7.

It is noted that one or more blocks (or operations) described with reference to FIGS. 4-6 may be combined with one or more blocks (or operations) described with reference to another of the figures. For example, one or more blocks (or operations) of FIG. 4 may be combined with one or more blocks (or operations) of FIG. 5. As another example, one or more blocks associated with FIG. 5 may be combined with one or more blocks associated with FIG. 6. As another example, one or more blocks associated with FIG. 4 may be combined with one or more blocks (or operations) associated with FIG. 6. Additionally, or alternatively, one or more operations described above with reference to FIGS. 1-3 may be combined with one or more operations described with reference to FIG. 7 or 8.

Although the above descriptions with reference to FIGS. 3-8 describe that a UE-side server may receive training information from a base station-side server and train an encoder using the received training information, the present disclosure is not limited thereto. For example, like the UE-side server, a UE may be configured to receive training information from the base station-side server and train an encoder using the received training information. In another example, a base station may be configured to generate the training information, as described with respect to the base station-side server and transmit the training information to other systems, devices, or nodes. That is, the above operations or steps performed by the UE-side server and the base station-side server may be performed by other systems, devices, or nodes, which does not fall outside the scope of the present disclosure.

In one or more aspects, techniques for supporting remote offline sequential network node training may include additional aspects, such as any single aspect or any combination of aspects described below or in connection with one or more other processes or devices described elsewhere herein. In a first aspect, supporting remote offline sequential network node training may include an apparatus configured to receive, from a second network node, training information for a first encoder of the first network node, wherein the training information comprises first input information for a second encoder of the second network node and output information corresponding to the first input information and train the first encoder of the first network node using the training information. Additionally, the apparatus may perform or operate according to one or more aspects as described below. In some implementations, the apparatus includes a network node, such as a UE-side server. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, alone or in combination with one or more of the above aspects, the first input information and the output information are included in one or more input-output tuples of the training information.

In a third aspect, alone or in combination with one or more of the above aspects, the first network node comprises a user equipment (UE) vendor-specific server and the second network node comprises a base station vendor-specific server.

In a fourth aspect, alone or in combination with one or more of the above aspects, the apparatus may be configured to transmit encoder parameters generated during training of the first encoder to a third network node, wherein the third network node comprises a user equipment (UE).

In a fifth aspect, alone or in combination with one or more of the above aspects, the first input information comprises raw channel information or singular vector information and the output information comprises encoded raw channel information or encoded singular vector information.

In a sixth aspect, alone or in combination with one or more of the above aspects, the apparatus may be further configured to transmit, to the second network node, second input information, wherein the first input information comprises the second input information.

In a seventh aspect, alone or in combination with one or more of the above aspects, apparatus may be further configured to receive the second input information from one or more user equipments (UEs), wherein the second input information comprises one or more measurements of one or more signals transmitted by a base station.

In an eighth aspect, alone or in combination with one or more of the above aspects, the first input information further comprises third input information received by the second network node from a third network node, wherein the first network node comprises a first user equipment (UE) vendor-specific server, and wherein the third network node comprises a second user equipment (UE) vendor-specific server different from the first UE vendor-specific server.

In a ninth aspect, alone or in combination with one or more of the above aspects, the first input information comprises second input information received, by the second network node, from a third network node, wherein the third network node comprises a base station.

In a tenth aspect, alone or in combination with one or more of the above aspects, the second input information comprises measurement information generated by the third network node.

In an eleventh aspect, alone or in combination with one or more of the above aspects, the second encoder is trained using the first input information prior to generating the output information.

In one or more aspects, techniques for supporting remote offline sequential network node training may include additional aspects, such as any single aspect or any combination of aspects described below or in connection with one or more other processes or devices described elsewhere herein. In a twelfth aspect, supporting remote offline sequential network node training may include an apparatus configured to remote offline sequential network node training and transmit the training information to a second network node for training a second encoder of the second network node. Additionally, the apparatus may perform or operate according to one or more aspects as described below. In some implementations, the apparatus includes a network node, such as a base station-side server. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a thirteenth aspect, alone or in combination with one or more of the above aspects, the first input information and the output information are included in one or more input-output tuples of the training information.

In a fourteenth aspect, alone or in combination with one or more of the above aspects, the first network node comprises a base station vendor-specific server and the second network node comprises a user equipment (UE) vendor-specific server.

In a fifteenth aspect, alone or in combination with one or more of the above aspects, the first input information comprises raw channel information or singular vector information and the output information comprises encoded raw channel information or encoded singular vector information.

In a sixteenth aspect, alone or in combination with one or more of the above aspects, the apparatus may be configured to receive, from the second network node, second input information, wherein the first input information comprises the second input information.

In a seventeenth aspect, alone or in combination with one or more of the above aspects, the second input information is received by the second network node from one or more user equipments (UEs) and wherein the second input information comprises one or more measurements of one or more signals transmitted by a base station.

In a eighteenth aspect, alone or in combination with one or more of the above aspects, the apparatus may be configured to receive, from a third network node, third input information, wherein the second network node comprises a first user equipment (UE) vendor-specific server, and wherein the third network node comprises a second user equipment (UE) vendor-specific server different from the first UE vendor-specific server.

In a nineteenth aspect, alone or in combination with one or more of the above aspects, the apparatus may be configured to receive, from a third network node, second input information, wherein the first input information comprises the second input information, and wherein the third network node comprises a base station.

In a twentieth aspect, alone or in combination with one or more of the above aspects, the second input information comprises measurement information from one or more measurements generated by the third network node.

In a twenty-first aspect, alone or in combination with one or more of the above aspects, the apparatus may be configured to train the first encoder using the first input information, wherein generating the training information is performed after training the first encoder.

In a twenty-second aspect, alone or in combination with one or more of the above aspects, the apparatus may be configured to train a first decoder of the first network node using the first input information.

In a twenty-third aspect, a method of wireless communication performed by a system including a first network node and a second network node may comprise: generating, by a second coder of the second network node, output information based on first input information; sending, by the second network node, training information for a first coder of the first network node to the first network node, wherein the training information comprises the output information of a second coder of the second network node and the corresponding first input information of the second coder of the second network node; and training the first coder of the first network node using the training information.

In a twenty-fourth aspect, a system may include a first network node and a second network node comprising means for performing the method according to the twenty-third aspect.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a network node may be a server, such as a UE-side server or a base station-side server. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In another aspect of this example, the first network node may be a UE-side server, the second network node may be a base station-side server, and the third network node may be a UE or a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-3 and 7-8 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent. As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a first network node, the method comprising:
receiving, from a second network node, training information for a first encoder of the first network node, wherein the training information comprises first input information for a second encoder of the second network node and output information corresponding to the first input information; and
training the first encoder of the first network node using the training information.

2. The method of claim 1, wherein the first input information and the output information are included in one or more input-output tuples of the training information, wherein the first input information comprises channel state feedback (CSF) information, and wherein the output information comprises encoded CSF information.

3. The method of claim 1, wherein the first network node comprises a user equipment (UE) vendor-specific server and the second network node comprises a base station vendor-specific server.

4. The method of claim 1, further comprising:
transmitting encoder parameters generated during training of the first encoder to a third network node, wherein the third network node comprises a user equipment (UE).

5. The method of claim 1, further comprising:
transmitting, to the second network node, second input information, wherein the first input information comprises the second input information.

6. The method of claim 5, further comprising:
receiving the second input information from one or more user equipments (UEs), wherein the second input information comprises one or more measurements of one or more signals transmitted by a base station.

7. The method of claim 5, wherein the first input information further comprises third input information received by the second network node from a third network node, wherein the first network node comprises a first user equipment (UE) vendor-specific server, and wherein the third network node comprises a second user equipment (UE) vendor-specific server different from the first UE vendor-specific server.

8. The method of claim 1, wherein the first input information comprises second input information received, by the second network node, from a third network node, wherein the second network node comprises a base station vendor-specific server, and wherein the third network node comprises a base station, and wherein the second input information comprises measurement information generated by the third network node.

9. A first network node comprising:
a memory; and
at least one processor coupled to the memory, wherein the at least one processor is configured to:
receive, from a second network node, training information for a first encoder of the first network node, wherein the training information comprises first input information for a second encoder of the second network node and output information corresponding to the first input information; and
train the first encoder of the first network node using the training information.

10. The first network node of claim 9, wherein the first input information and the output information are included in one or more input-output tuples of the training information.

11. The first network node of claim 9, wherein the first network node comprises a user equipment (UE) vendor-specific server and the second network node comprises a base station vendor-specific server, wherein the first input information comprises channel state feedback (CSF) information, and wherein and the output information comprises encoded CSF information.

12. The first network node of claim 9, wherein the at least one processor is further configured to:
transmit encoder parameters generated during training of the first encoder to a third network node, wherein the third network node comprises a user equipment (UE).

13. The first network node of claim 9, wherein the at least one processor is further configured to:
transmit, to the second network node, second input information, wherein the first input information comprises the second input information.

14. The first network node of claim 13, wherein the at least one processor is further configured to:
receive the second input information from one or more user equipments (UEs), wherein the second input information comprises one or more measurements of one or more signals transmitted by a base station.

15. The first network node of claim 13, wherein the first input information further comprises third input information received by the second network node from a third network node, wherein the first network node comprises a first user equipment (UE) vendor-specific server, and wherein the third network node comprises a second user equipment (UE) vendor-specific server different from the first UE vendor-specific server.

16. The first network node of claim 9, wherein the first input information comprises second input information received, by the second network node, from a third network node, wherein the second network node comprises a base station vendor-specific server, wherein the third network node comprises a base station, and wherein the second input information comprises measurement information generated by the third network node.

17. A method of wireless communication performed by a first network node, the method comprising:
generating training information, wherein the training information comprises first input information for a first encoder of the first network node and output information generated, based on the first input information, by the first encoder; and
transmitting the training information to a second network node for training a second encoder of the second network node.

18. The method of claim 17, wherein the first input information and the output information are included in one or more input-output tuples of the training information, wherein the first input information comprises channel state feedback (CSF) information and the output information comprises encoded CSF information.

19. The method of claim 17, wherein the first network node comprises a base station vendor-specific server and the second network node comprises a user equipment (UE) vendor-specific server.

20. The method of claim 17, further comprising:
receiving, from the second network node, second input information, wherein the first input information comprises the second input information, wherein the second input information is received by the second network node from one or more user equipments (UEs), and wherein the second input information comprises one or more measurements of one or more signals transmitted by a base station.

21. The method of claim 20, further comprising:
receiving, from a third network node, third input information, wherein the second network node comprises a first user equipment (UE) vendor-specific server, and wherein the third network node comprises a second user equipment (UE) vendor-specific server different from the first UE vendor-specific server.

22. The method of claim 17, further comprising
receiving, from a third network node, second input information, wherein the first input information comprises the second input information, wherein the third network node comprises a base station, and wherein the second input information comprises measurement information generated by the third network node.

23. The method of claim 17, further comprising:
training the first encoder using the first input information, wherein generating the training information is performed after training the first encoder; and
training a first decoder of the first network node using the first input information.

24. A first network node, comprising:
a memory; and
at least one processor coupled to the memory, wherein the at least one processor is configured to:
generate training information, wherein the training information comprises first input information for a first encoder of the first network node and output information generated, based on the first input information, by the first encoder; and
transmit the training information to a second network node for training a second encoder of the second network node.

25. The first network node of claim 24, wherein the first input information and the output information are included in one or more input-output tuples of the training information, wherein the first input information comprises channel state feedback (CSF) information and the output information comprises encoded CSF information.

26. The first network node of claim 24, wherein the first network node comprises a base station vendor-specific server and the second network node comprises a user equipment (UE) vendor-specific server.

27. The first network node of claim 24, wherein the at least one processor is further configured to:
receive, from the second network node, second input information, wherein the first input information comprises the second input information, wherein the second input information is received by the second network node from one or more user equipments (UEs) and wherein the second input information comprises one or more measurements of one or more signals transmitted by a base station.

28. The first network node of claim 27, wherein the at least one processor is further configured to:
receive, from a third network node, third input information, wherein the second network node comprises a first user equipment (UE) vendor-specific server, and wherein the third network node comprises a second user equipment (UE) vendor-specific server different from the first UE vendor-specific server.

29. The first network node of claim 24, wherein the at least one processor is further configured to:
receive, from a third network node, second input information, wherein the first input information comprises the second input information, and wherein the third network node comprises a base station, and wherein the second input information comprises measurement information generated by the third network node.

30. The first network node of claim 24, wherein the at least one processor is further configured to:
train the first encoder using the first input information, wherein generating the training information is performed after training the first encoder; and
train a first decoder of the first network node using the first input information.
